(19) United States
(12) Patent Application Publication
(10) Pub. No.: US 2005/0013333 A1
(43) Pub. Date: Jan. 20, 2005

(54) Solid state laser cooling device

(75) Inventor: Jae Wook Kwon, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/892,878

(22) Filed: Jul. 16, 2004

(30) Foreign Application Priority Data
Jul. 18, 2003 (KR) P10-2003-49200

(51) Int. Cl. H01S 3/04

(52) U.S. Cl. 372/34; 372/36

(57) ABSTRACT

A solid state laser cooling device is disclosed. The device includes a pumping source generating light, a laser medium generating a resonant light from the pumped light, a heat exchanger treating heat generated from the laser medium, a metal mount supporting the heat exchanger and transferring heat to the heat exchanger, a heat transfer material transferring heat to the metal mount, and an interface material formed between the laser medium and the heat transfer material, so as to enhance a heat transfer efficiency. In another aspect of the present invention, the solid state laser cooling device includes a pumping source generating light, a laser medium including an added material for enhancing cooling efficiency and optical output, and a pair of metal mounts separated from each other and adhered to the laser medium.

### CROSS-REFERENCE TO RELATED APPLICATIONS

This application claims the benefit of Korean Application No. P2003-049200, filed on Jul. 18, 2003, which is hereby incorporated by reference as if fully set forth herein.

### BACKGROUND OF THE INVENTION

1. Field of the Invention

The present invention relates to a laser device, and more particularly, to a solid state laser cooling device. Although the present invention is suitable for a wide scope of applications, it is particularly suitable for reducing thermal contact resistance between a laser medium and a heat transfer material, thereby reducing a thermal lens effect and enhancing optical characteristics of the device.

2. Discussion of the Related Art

Laser refers to a light amplification by a stimulated emission of radiation (LASER) and is operated by optical and electronic devices. The laser is being extensively developed for industrial use, medical use, and research. And, in recent technology, active research is carried out for developing the application of laser in household display media. Herein, the visible laser requiring compact size, high efficiency, and high output, which is applied in household usage, includes a diode pumped solid state (DPSS) laser. Depending upon the laser medium, the laser can be categorized as gaseous laser, liquid laser, solid (or solid state) laser, and semiconductor laser.

When a high output laser is generated, the laser medium of the solid state laser has a structural characteristic of generating heat within small areas. More specifically, in case of non-linear optical materials used in the laser medium and laser oscillators, heat is generated from the energy of pumped light or resonant light, and this heat causes a variation in the refractive index of the materials. More specifically, the amount of thermal energy at the center of the materials is different from that of the surrounding area of the materials, thereby causing a difference in the refractive index between the center and the surrounding area of the materials.

When such difference in refractive index occurs, the optical path is changed in accordance with the level of difference. At this point, the optical materials act as a lens, which can also be referred to as the thermal lens effect. The thermal lens effect deteriorates the capacity of the laser, and so cooling the laser medium is a very critical process. Accordingly, in the related art, a material having high heat conductivity is attached to the laser medium, so as to externally disperse the heat generated from the laser medium, by generally using methods such as optical contact and optical bonding.

Optical contact is a method of adhering a material having an excellent heat transfer efficiency to the surrounding area of the laser medium, in a clean vacuum state. Optical bonding is a method of inducing a chemical bonding between the laser medium and a material, which is similar to the laser medium but having a different substituent, under a constant condition. In the optical contact method, since the laser passes through the material high in heat conductivity, transparency of the material is required.

However, all of the above-described methods include the process of adhering the laser medium and other materials, thereby causing the disadvantages and problems described below.

In the optical contact method, since materials having different properties are being attached to one another, the stability of the adhesive surface is deteriorated. When the pumping rate of the light is increased, the adhesive surface can be detached due to a difference in the thermal expansion index between the heterogenous materials.

Also, due to the thermal expansion, the optical characteristic on the adhesive surface can be easily deteriorated. And, a larger amount of time and money is consumed due to the additional adhesion process.

Finally, in the optical bonding method, the selection of materials having excellent heat transfer efficiency, on which the laser medium can be adhered, is limited.

### SUMMARY OF THE INVENTION

Accordingly, the present invention is directed to a solid state laser cooling device that substantially obviates one or more problems due to limitations and disadvantages of the related art.

An object of the present invention is to provide a solid state laser cooling device having an interface material, which can be easily deformed, inserted therein so as to reduce the thermal contact resistance between a laser medium and a heat transfer material, thereby reducing a thermal lens effect and enhancing optical characteristics of the device.

Another object of the present invention is to provide a solid state laser cooling device having an added material included therein, thereby enhancing the cooling efficiency and the optical output of the laser light ray.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a solid state laser cooling device includes a pumping source generating light, a laser medium generating a resonant light from the pumped light, a heat exchanger treating heat generated from the laser medium, a metal mount supporting the heat exchanger and transferring heat to the heat exchanger, a heat transfer material transferring heat to the metal mount, and an interface material formed between the laser medium and the heat transfer material, so as to enhance a heat transfer efficiency.

Herein, the metal mount is formed of a metal having high heat conductivity.

The heat transfer material is formed of any one of sapphire, silicon carbide, and diamond. Herein, the heat transfer material is formed of a transparent material.

Also, surfaces of the laser medium and the heat transfer material contacting the interface material are treated to have a uniform and smooth surface.

The interface material is formed of a transparent and thin film. Herein, the interface material is formed in one of a liquid type and a gel type. Also, the interface material is formed of any one of silicon oil, glycerin, and silicon rubber.

In another aspect of the present invention, a solid state laser cooling device includes a pumping source generating light, a laser medium including an added material for enhancing cooling efficiency and optical output, and a pair of metal mounts separated from each other and adhered to the laser medium.

The added material included in the laser medium has a different concentration and position depending upon a trajectory and intensity of the pumped light.

Herein, the added material has a low concentration, in an area of the laser medium near a laser light ray incident surface, and has a high concentration, in a surface facing into the light incident surface, the light incident surface being an area of the laser medium near a surface whereby the laser light ray is outputted.

Alternatively, the added material can also have a high concentration, in an area of the laser medium near a laser light ray incident surface, and have a low concentration, in a surface facing into the light incident surface, the light incident surface being an area of the laser medium near a surface whereby the laser light ray is outputted.

Also, from the direction of the laser light ray passing through the laser medium, the added material has a low concentration when near each end of the laser medium, and has a high concentration at a central area of the laser medium. Alternatively, from the direction of the laser light ray passing through the laser medium, the added material can also have a high concentration when near each end of the laser medium, and have a low concentration at a central area of the laser medium.

Herein, the added material has a relatively high concentration in a plurality of stripe-formed areas on the laser medium, and is formed of one of neodymium (Nd) and thulium (Tm).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates the structure of a general solid state laser;

FIG. 2 illustrates the structure of a solid state laser cooling device according to a first embodiment of the present invention;

FIG. 3 illustrates a cross-sectional view of the solid state laser cooling device and a doping concentration distribution chart of an added material according to a second embodiment of the present invention;

FIG. 4 illustrates a cross-sectional view of the solid state laser cooling device and a doping concentration distribution chart of the added material according to a third embodiment of the present invention;

FIG. 5 illustrates a plan view of the solid state laser cooling device and a doping concentration distribution chart of the added material according to a fourth embodiment of the present invention;

FIG. 6 illustrates a plan view of the solid state laser cooling device and a doping concentration distribution chart of the added material according to a fifth embodiment of the present invention;

FIG. 7 illustrates a plan view of the solid state laser cooling device and a doping concentration distribution chart of the added material according to a sixth embodiment of the present invention; and

FIG. 8 illustrates a schematic view of a laser oscillator according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

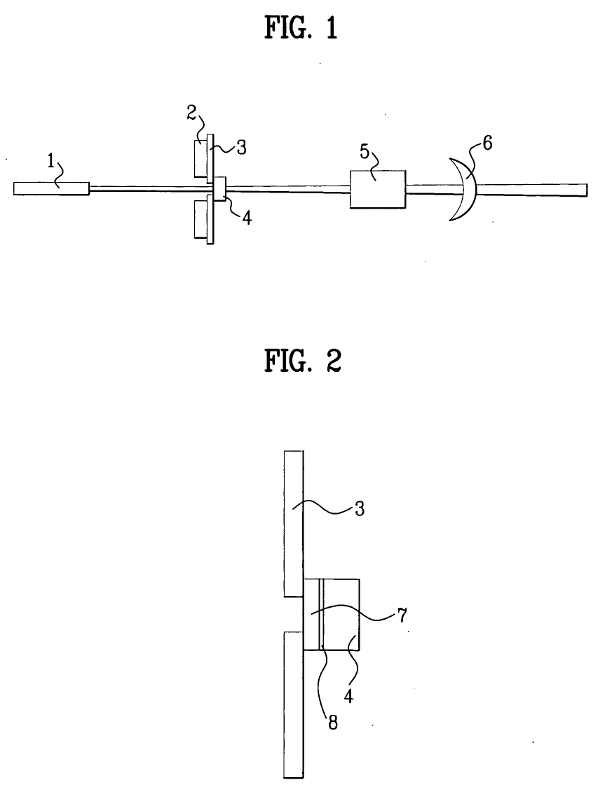

FIG. 1 illustrates the structure of a general solid state laser.

Referring to FIG. 1, the solid state laser is formed of a pumping source 1, a heat exchanger 2, a metallic mount 3, a laser medium 4, a nonlinear optical material 5, and an output coupler 6. Herein, a pumping laser diode is used as the pumping source 1. And, one of ruby and neodymium doped yttrium aluminum garnet (Nd:YAG) is used as the solid state laser medium 4.

When light is pumped from the pumping source 1, the light is irradiated to the laser medium 4. The light irradiated to the laser medium 4 is then changed into light rays of ultra violet (UV) wavelengths. And, the light rays of the UV wavelengths generate a resonance between the laser medium 4 and the output coupler 6.

The resonated light rays of the UV wavelengths pass through the nonlinear optical material 5. Due to a second harmonic generation (SHG), the nonlinear optical material 5 changes the resonance wavelength (λ) into a half of the resonance wavelength (λ/2). Then, the light oscillating because of the nonlinear optical material is outputted through the output coupler 6.

FIG. 2 illustrates the structure of a solid state laser cooling device according to a first embodiment of the present invention.

As shown in FIG. 2, the solid state laser cooling device includes a metal mount 3, a heat transfer material 7, and an interface material 8. The heat transfer material 7 should have a high heat conductivity in order to disperse the heat generated from the laser medium 4 within a short period of time. Therefore, sapphire, silicon carbide, diamond, and so on are used as the heat transfer material 7. Also, since the heat transfer material 7 is positioned on the optical path of the laser, the heat transfer material 7 should be formed of a transparent material.

Subsequently, each of the upper and lower portions of the heat transfer material 7 is adhered to the metal mount 3. Herein, the metal mount 3 is also formed of a metal having high heat conductivity, such as copper, in order to increase the heat transfer efficiency. Then, the metal mount 3 sends the heat received from the heat transfer material 7 to the heat exchanger (not shown).

Meanwhile, in the present invention, an interface material 8 is inserted between the laser medium 4 and the heat transfer material 7. The interface material 8 is formed of a thin film. And, it is preferable that the surfaces of the heat transfer material 7 and the laser medium 4 contacting the interface material 8 is treated to form a flat and smooth surface. When the layer between the flat and smooth surfaces is formed as a thin film, the binding force between the heat transfer material 7 and the laser medium 4 is enhanced, thereby preventing the thin film from being detached.

If the light is pumped from the pumping source at a high output, the heat generation from the laser medium 4 is increased. Accordingly, the contacting surface between the laser medium 4 and the heat transfer material 7 can be deformed from a flat surface to a curved surface. Therefore, a rubber or gel type material is used as the interface material 8. More specifically, silicon oil, glycerin, silicon rubber, and so on can be used as the interface material 8.

Depending upon the external pressure, the rubber or gel type materials can be easily deformed. Therefore, when the surface of the laser medium 4 becomes curved due to the light pumped at a high output, the interface material 8 also becomes curved accordingly. Thus, the adhesion between the laser medium 4 and the heat transfer material 7 can be maintained.

As described above, the interface material 8 reduces the thermal contact resistance between the laser medium 4 and the heat transfer material 7, thereby facilitating the transfer of the heat generated from the laser medium 4. Additionally, the interface material 8 can stabilize the optical characteristics between the transparent heat transfer material 7 and the laser medium 4, which are materials different from one another.

The above-described solid state laser cooling device according to the first embodiment of the present invention has the following advantages.

By using an interface material that can be easily deformed, the interface material can absorb the deformation of a laser medium, when the surface of the laser medium is deformed to a curved surface due to the heat. Accordingly, the adhesion between the laser medium and the heat transfer material can be maintained.

Also, the interface material reduces a thermal contact resistance between the laser medium and the heat transfer material, thereby enhancing the heat transfer efficiency.

Finally, the interface material can stabilize the optical characteristics between the laser medium and the heat transfer material.

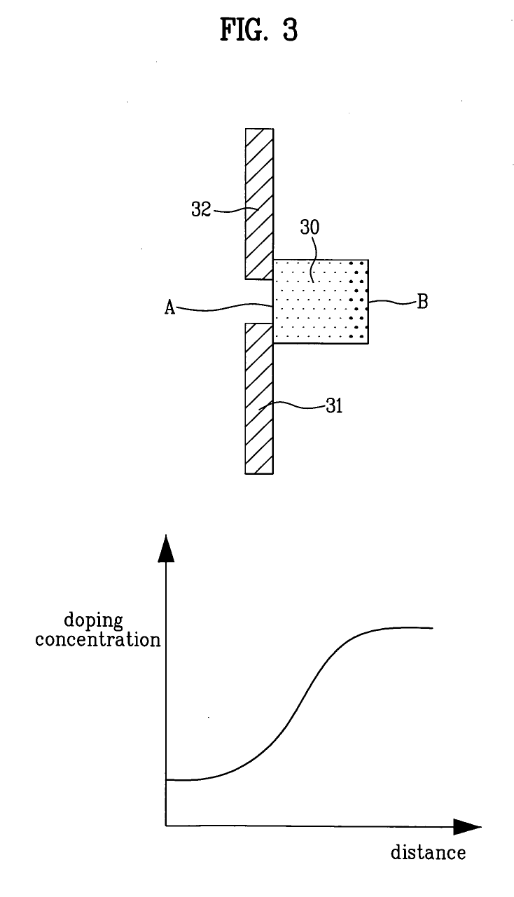

FIG. 3 illustrates a cross-sectional view of the solid state laser cooling device and a doping concentration distribution chart of an added material according to a second embodiment of the present invention.

The laser medium 30 according to the present invention includes an added material for enhancing cooling efficiency and optical output. Herein, neodymium (Nd) or thulium (Tm) can be used as the added material. Also, a pair of metal mounts 31 and 32 each spaced apart from each other is formed on the laser medium 30. As shown in the chart of FIG. 3, in the surface where the laser medium is adhered to the metal mounts 31 and 32 (i.e., surface A), in other words, the area of the laser medium near the laser light ray incident surface, the doping concentration of the added material is low. Conversely, in the surface facing into the surface A (i.e., surface B), in other words, the area of the laser medium near the surface whereby the laser light ray is outputted, the doping concentration of the added material is high.

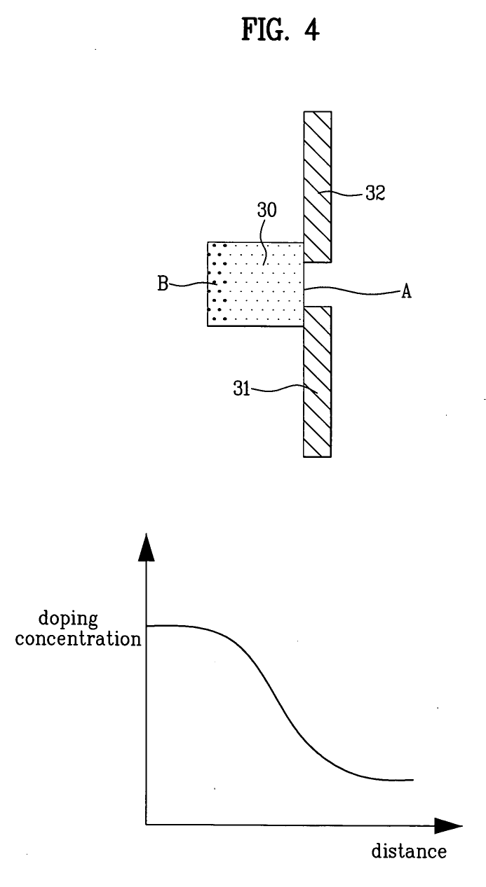

When a large amount of added material is doped on the laser medium 30, a larger amount of heat is generated. On the other hand, when a small amount of added material is doped on the laser medium 30, less heat is generated. Therefore, depending upon the shape of the pumped light according to the present invention, the concentration of the added material is applied differently for each area within the laser medium 30. By varying the doping concentration of the added material, as shown in FIGS. 4 to 7, in accordance with the shape of the light ray being incident to the laser medium, the structure of the peripheral device, the function of the laser medium, the trajectory and intensity of the pumped laser light ray, and so on, the heat generated from the laser medium can be uniformly cooled and the laser light ray output can be increased.

Meanwhile, the laser medium can allow the growth of materials, such as yittrium orthovanadate (YVO₄), at a high temperature condition of approximately 2000° C., and simultaneously, the addition of materials, such as neodymium (Nd) or thulium (Tm). Then, when the crystal growth is processed to a desired size, the fabrication process is completed by carrying out a slow and gradual cooling process.

FIG. 4 illustrates a cross-sectional view of the solid state laser cooling device and a doping concentration distribution chart of the added material according to a third embodiment of the present invention.

Referring to FIG. 4, a pair of metal mounts 31 and 32 is adhered to an optical output end of the laser medium 30. Then, in the surface where the laser medium is adhered to the metal mounts 31 and 32 (i.e., surface A), in other words, the area of the laser medium near the surface whereby the laser light ray is outputted, the doping concentration of the added material included in the laser medium 30 is low. Conversely, in the surface facing into the surface A (i.e., surface B), in other words, the area of the laser medium near the laser light ray incident surface, the doping concentration of the added material is high.

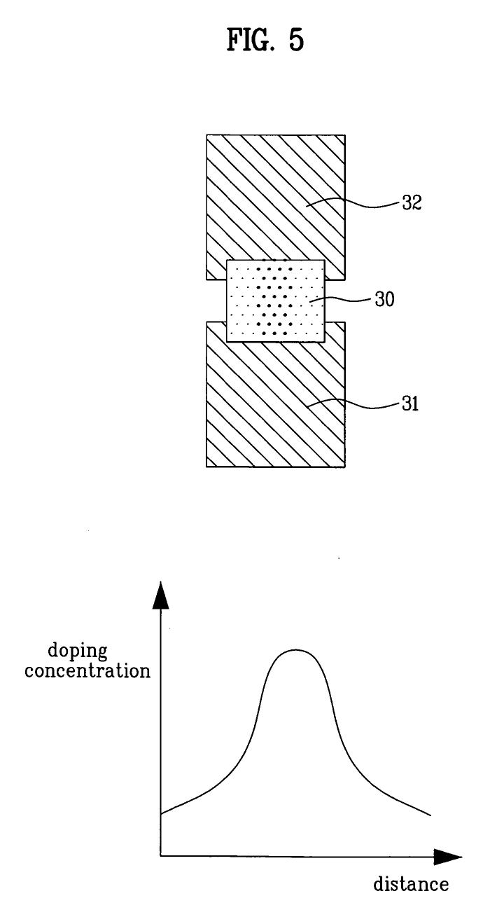

FIG. 5 illustrates a plan view of the solid state laser cooling device and a doping concentration distribution chart of the added material according to a fourth embodiment of the present invention.

From the direction of the laser light ray passing through the laser medium, the concentration of the added material is low when near each end of the laser medium, and the concentration is high at the central area of the laser medium.

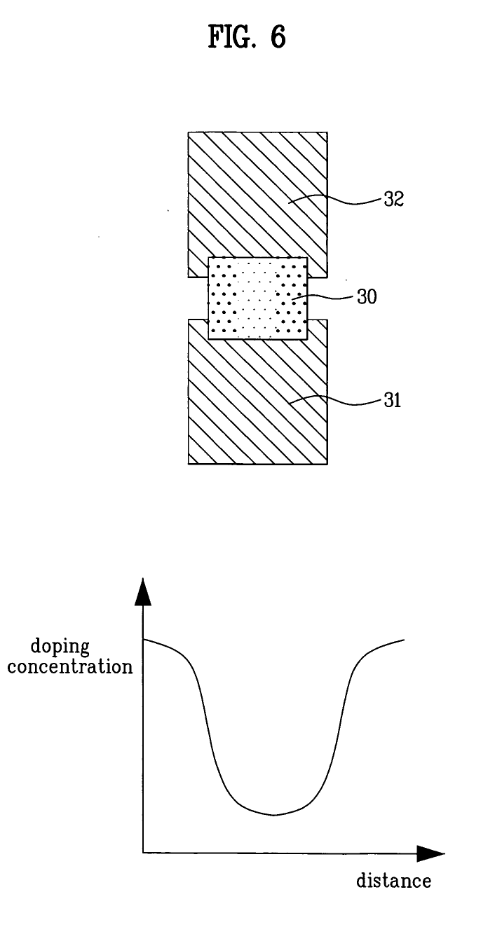

FIG. 6 illustrates a plan view of the solid state laser cooling device and a doping concentration distribution chart of the added material according to a fifth embodiment of the present invention.

From the direction of the laser light ray passing through the laser medium, the concentration of the added material is high at the central area of the laser medium, and the concentration is low when near each end of the laser medium.

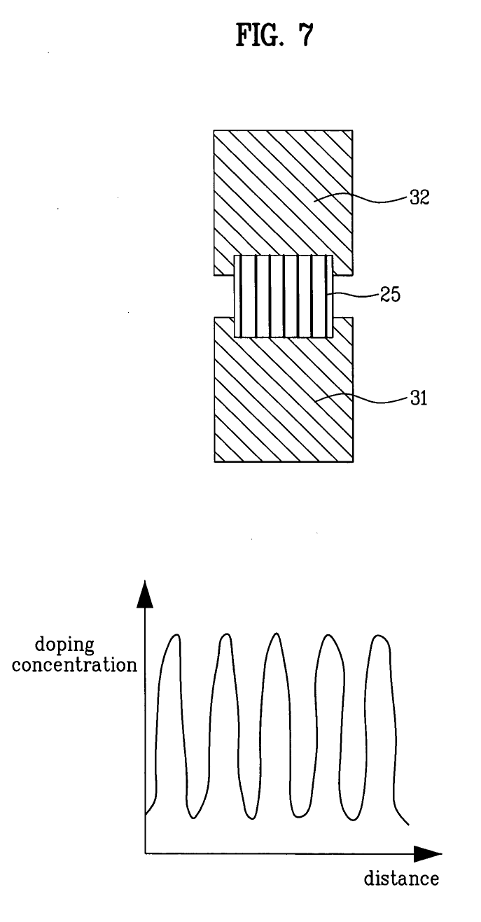

FIG. 7 illustrates a plan view of the solid state laser cooling device and a doping concentration distribution chart of the added material according to a sixth embodiment of the present invention.

Referring to FIG. 7, the highly concentrated added material is formed in a plurality of stripe-formed areas 25 on the laser medium. As described above, depending upon the position of the laser medium, the solid state laser cooling device according to the second and sixth embodiments of the present invention can vary the concentration distribution of the added material included in the laser medium, which is based on the shape of the light ray being incident to the laser medium, the structure of the peripheral device, and the function of the laser medium.

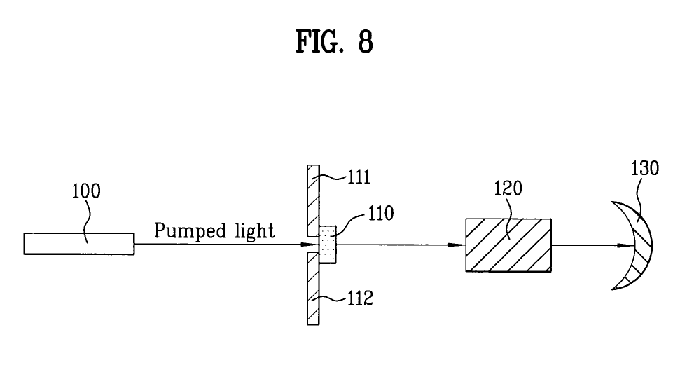

FIG. 8 illustrates a schematic view of a laser oscillator according to the second embodiment of the present invention.

Referring to FIG. 8, the laser oscillator includes a pumping source 100, a laser medium 110, a nonlinear optical material 120, and an output coupler 130. The laser medium 110 allows pumped light to pass through, and also includes an added material for enhancing the cooling efficiency and optical output. A pair of metal mounts 111 and 112 spaced apart from each other is also adhered to the laser medium 110.

As described above, the solid state laser cooling device according to the second embodiment of the present invention has the following advantages.

The solid state laser cooling device according to the present invention can vary the concentration distribution of the added material included in the laser medium, which is based on the shape of the light ray being incident to the laser medium, the structure of the peripheral device, and the function of the laser medium, depending upon the position of the laser medium. Thus, the heat generated from the laser medium can be uniformly cooled, and the optical output can be enhanced.

Furthermore, the related art process of attaching a transparent heat transfer material can be removed, thereby providing a highly reliable and low-costing laser medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A solid state laser cooling device, comprising:
a pumping source generating light;
a laser medium generating a resonant light from the pumped light;
a heat exchanger treating heat generated from the laser medium;
a metal mount supporting the heat exchanger and transferring heat to the heat exchanger;
a heat transfer material transferring heat to the metal mount; and
an interface material formed between the laser medium and the heat transfer material, so as to enhance a heat transfer efficiency.

2. The device according to claim 1, wherein the metal mount is formed of a metal having high heat conductivity.

3. The device according to claim 1, wherein the heat transfer material is formed of any one of sapphire, silicon carbide, and diamond.

4. The device according to claim 1, wherein the heat transfer material is formed of a transparent material.

5. The device according to claim 1, wherein surfaces of the laser medium and the heat transfer material contacting the interface material are treated to have a uniform and smooth surface.

6. The device according to claim 1, wherein the interface material is formed of a transparent and thin film.

7. The device according to claim 1, wherein the interface material is formed in one of a liquid type and a gel type.

8. The device according to claim 1, wherein the interface material is formed of any one of silicon oil, glycerin, and silicon rubber.

9. A solid state laser cooling device, comprising:
a pumping source generating light;
a laser medium including an added material for enhancing cooling efficiency and optical output; and
a pair of metal mounts separated from each other and adhered to the laser medium.

10. The device according to claim 9, wherein the added material included in the laser medium has a different concentration and position depending upon a trajectory and intensity of the pumped light.

11. The device according to claim 10, wherein the added material has a low concentration, in an area of the laser medium near a laser light ray incident surface, and has a high concentration, in a surface facing into the light incident surface, the light incident surface being an area of the laser medium near a surface whereby the laser light ray is outputted.

12. The device according to claim 10, wherein the added material has a high concentration, in an area of the laser medium near a laser light ray incident surface, and has a low concentration, in a surface facing into the light incident surface, the light incident surface being an area of the laser medium near a surface whereby the laser light ray is outputted.

13. The device according to claim 10, wherein from the direction of the laser light ray passing through the laser medium, the added material has a low concentration when near each end of the laser medium, and has a high concentration at a central area of the laser medium.

14. The device according to claim 10, wherein from the direction of the laser light ray passing through the laser medium, the added material has a high concentration when near each end of the laser medium, and has a low concentration at a central area of the laser medium.

15. The device according to claim 10, wherein the added material has a relatively high concentration in a plurality of stripe-formed areas on the laser medium.

16. The device according to claim 10, wherein the added material is formed of one of neodymium (Nd) and thulium (Tm).
